(19) United States
(12) Patent Application Publication
(10) Pub. No.: US 2004/0166484 A1
(43) Pub. Date: Aug. 26, 2004

(54) System and method for simulating training scenarios

(76) Inventors: Mark Alan Budke, Cincinnati, OH (US); Michael Lee Bordner, Cincinnati, OH (US); Richard James Horn, Cincinnati, OH (US)

Correspondence Address: FROST BROWN TODD LLC, 2200 PNC Center, 201 E. Fifth Street, Cincinnati, OH, 45202-4182, US

(21) Appl. No.: 10/740,054

(22) Filed: Dec. 18, 2003

Related U.S. Application Data
(60) Provisional application No. 60/435,160, filed on Dec. 20, 2002.

(51) Int. Cl. G09B 1/00

(52) U.S. Cl. 434/433

(57) ABSTRACT

This application discloses a system and method for developing computerized simulations for training purposes.

### PRIORITY OF THE INVENTION

This is a non-provisional application based upon an earlier filed provisional application, Serial No. 60/435,160 filed Dec. 20, 2002. That provisional application is hereby incorporated by reference into the current application.

### FIELD OF INVENTION

This invention is in the field of computerized simulations.

### BACKGROUND

The main problem with existing computerized simulation products is that they do not address the needs of the commercial and corporate industry training and simulation needs.

Another problem with existing products is that they do not allow customizable training modules for the commercial and corporate environment within a three-dimensional world.

### SUMMARY OF THE INVENTION

Embodiments of the system and method disclosed in this application address a need in the industry for a robust method and system for a computer software situation simulator, which utilizes three-dimensional graphic technology and computer programming to train and educate employees.

Embodiments of this invention include a system and method for computerized training, which includes designing a three-dimensional computerized simulation deployed over a two-dimensional media. It may also comprise a computerized program comprising computer executable instructions on a computer readable medium. The computerized simulation may be a representation of the real world in a computer program. In the various embodiments disclosed, it should be understood that the simulation will be deployed over a two-dimensional media, such as a computer monitor, television screen, PDA, or equivalent media with imaging technology. Future embodiments may include a simulation deployed over a holographic medium or other three-dimensional media.

The simulation reproduces a training environment by programming at least one scenario comprising a projected or imagined sequence of events. The training environment represents the particular field in which the user will perform functions practiced in the computerized simulation. For example, the training environment may be corporate, sales, law, medicine, or technical help. A scenario may include elements, which may be interactions that may occur in the setting chosen for the training simulation. A scenario may include at least one of the following set elements: meetings, phone calls, pages, e-mails, conversations, key information disclosures, and debriefings. These elements may be used to support a main storyline or may be used to support side storylines or subplots within the simulation.

Embodiments of this invention may also include programming at least one character in the training environment to interact with a user. The character may interact with the user when the user encounters the character in the simulation. The character may communicate with the user or merely react to the user's input. User inputs may include any actions that may be promulgated within the simulation by the user in response to the environment that is presented to the user. The character may provide feedback to the user by taking on at least one emotional state in reaction to a user's input. The emotional state may be happy, satisfied, neutral, unconvinced, confused, bored, sad, frustrated, angry, or any other expressive feeling.

The character's emotional state may be reflected in at least one simulated reaction to the user. For instance, the reaction may include a set of positive statements and questions from the character when the character's emotional state is positive. Similarly, the reaction may comprise a set of neutral or negative statements and questions from the character when the character's emotional state is respectively neutral or negative.

In addition, the character may have attributes, which may define interests or characteristics of the character. The character attributes may be scaled by a predetermined formula to indicate an interest level for the character attribute. The character attributes may indicate the character's interest level in implementation, cost, security, quality, competition, features, scalability/upgrades, and revenue. Further, a user input may cause a group of characters to each develop an emotional state based upon each character's attributes and the scaling associated with each character's attributes.

Programming may be provided for the training environment to calculate a score for at least one user input and, based on that score, provide a set of feedback to the user relating to the user's success with the element. Programming may also be provided to calculate a final score from the user's input and, based on the final score, provide a set of feedback to the user relating to the user's success with the simulation as a whole. This feedback may include a projected outcome of the simulation.

The simulation may be programmed to replicate various training situations. In one embodiment, the simulation may be programmed to replicate a trial situation to train a new attorney. This simulation may take place in a courtroom and may include various interactions with characters such as a judge, a jury, a client, and/or an opposing attorney. In another embodiment, the simulation may be programmed to replicate a job interview or a series of job interviews. This simulation may take place in an office or conference room and may include interaction with characters such as an interviewer and/or an office greeter.

Another embodiment of the invention may include designing a three-dimensional computerized simulation deployed over a two-dimensional media, wherein the simulation reproduces a training environment for telephony sales. The simulation may comprise at least four scenes including overview/discovery, technical/design, financial justification, and close.

This simulation may include one or more of the following characters: a chief information officer, a chief financial officer, a chief executive officer, an internet telephony manager, and a voice communications officer. The chief information officer may be the person responsible for the information technology and computer systems that support the business. The chief financial officer may be the person who manages the books or serves as the treasurer of a business. The chief executive officer may be the President or chief spokesperson for the business. The internet telephony manager may be the person in charge of internet based telecommunications for the business. Finally, the voice communications officer may be the person that manages voice network communications for the business.

Additionally, a scenario in the simulation may include a user presentation of a telephony system to a group of characters, each of which may have different character attributes. Programming may be provided for the training environment to calculate a score associated with the scenario based on a formula, which weights each of the character's reactions to the user presentation. A scenario could also require a user to provide input relating to return on investment and the score associated with the scenario could then be based on the user's providing information relevant to a set of needs and current expenses of a business. Another embodiment may include a scenario that presents the user with an opportunity to provide information relating to at least one competitive system.

Other embodiments may include programming a multitude of storyline paths. The storyline paths may include one or more scenarios linked together by subject matter. The computerized simulation may be further programmed to alternate between storyline paths based on the user's input. The simulation may also be programmed to allow the user to deviate from and return to a main storyline within the multitude of storyline paths.

### BRIEF DESCRIPTION OF THE DRAWINGS

Preferred embodiments are provided in the accompanying detailed description which may be best understood in conjunction with the accompanying diagrams where like parts in each of the several diagrams are labeled with like numbers, and where:

FIG. 1 provides a table, which illustrates how certain responses will trigger certain threads/rules.

FIG. 2 provides a table which illustrates a matrix of various attributes, defined in one simulation embodiment, that may be used to define simulation characters by applying an interest percentage for each attribute to be associated with each character.

FIG. 3 illustrates various matrices, which illustrate how final scoring may be conducted in one scoring embodiment of the invention.

FIG. 4 illustrates a screenshot of the briefcase functionality in one embodiment of the invention wherein customized background information may be presented to the user.

FIG. 5 illustrates an example screen shot where the user is placed at a client site to navigate to their next meeting or encounter a subplot.

FIG. 6 illustrates an example screen shot wherein the user may encounter an unplanned situation.

FIG. 7 illustrates an example screen shot wherein the user may select from several presented choices in an initial meeting scenario.

FIG. 8 illustrates an example screen shot of a higher level meeting wherein the user may be required to choose from somewhat more complex options in their response to issues posed by the simulation client characters.

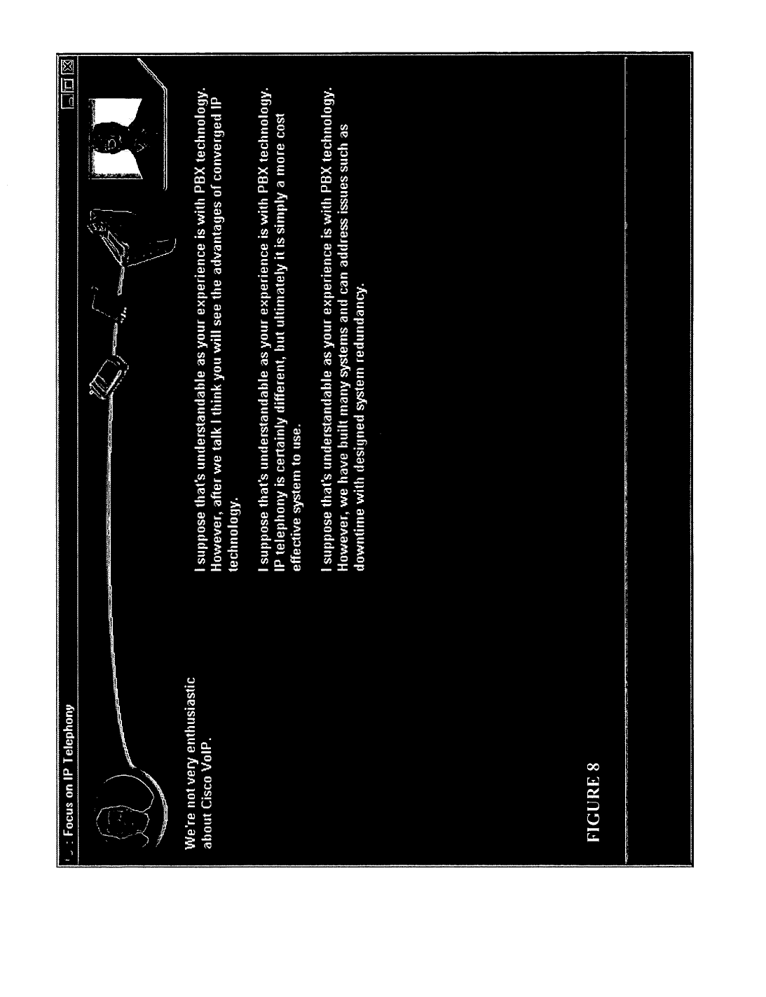

### DETAILED DESCRIPTION OF THE EMBODIMENTS

Various embodiments of the invention comprise computerized engines developed to render dynamic conversational-based situations and environments. These situations and environments may be described in an XML markup language, preferably or proprietary language designed to facilitate such construction markup language. The engine may track key events that occur in the environment through user interactions. The engine may use these events as well as participant reactions to user interactions to proceed through the various multi branching conversation situations.

The Simulation

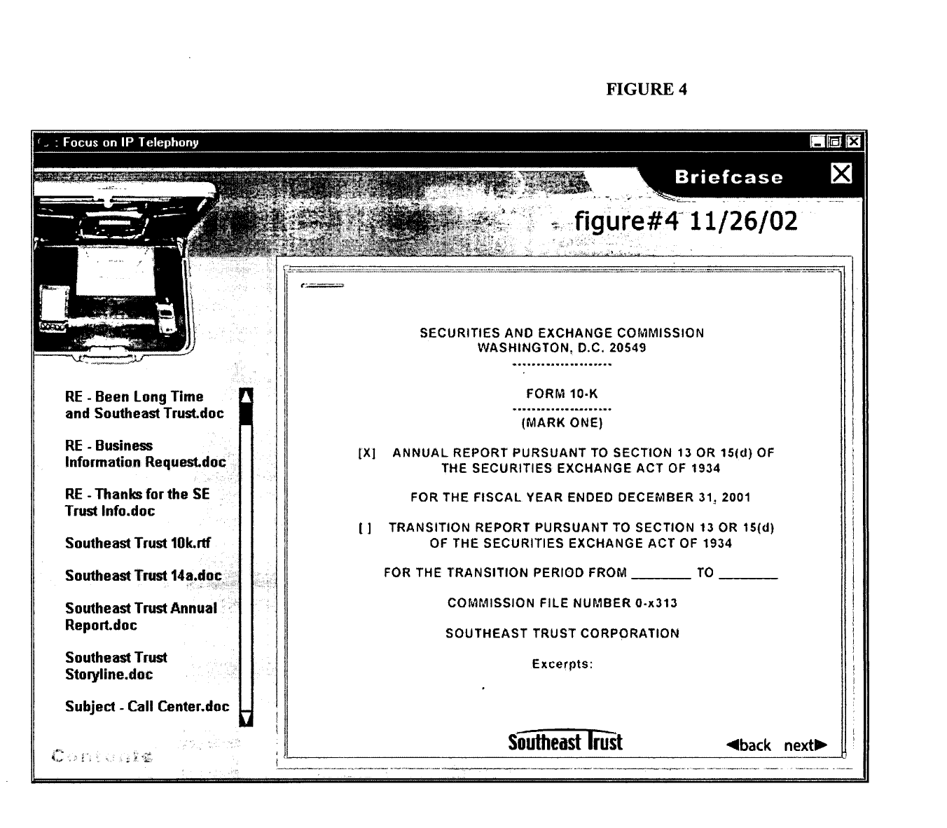

A simulation may begin in a user's office where telephone calls and email messages may be received. Several tools may be made available for use anytime during the simulation including a PDA, cell phone, access to the Internet, and a briefcase. Referring to FIG. 4, the user can access customized material and external Internet links from within the simulation. The user may assume the position of the “camera” in the simulation (i.e., the user is in the 1st person and viewing the scene through the eyes of the Player character). Alternate positions may also be possible in the simulation. The user may also choose different models to represent him in the simulation.

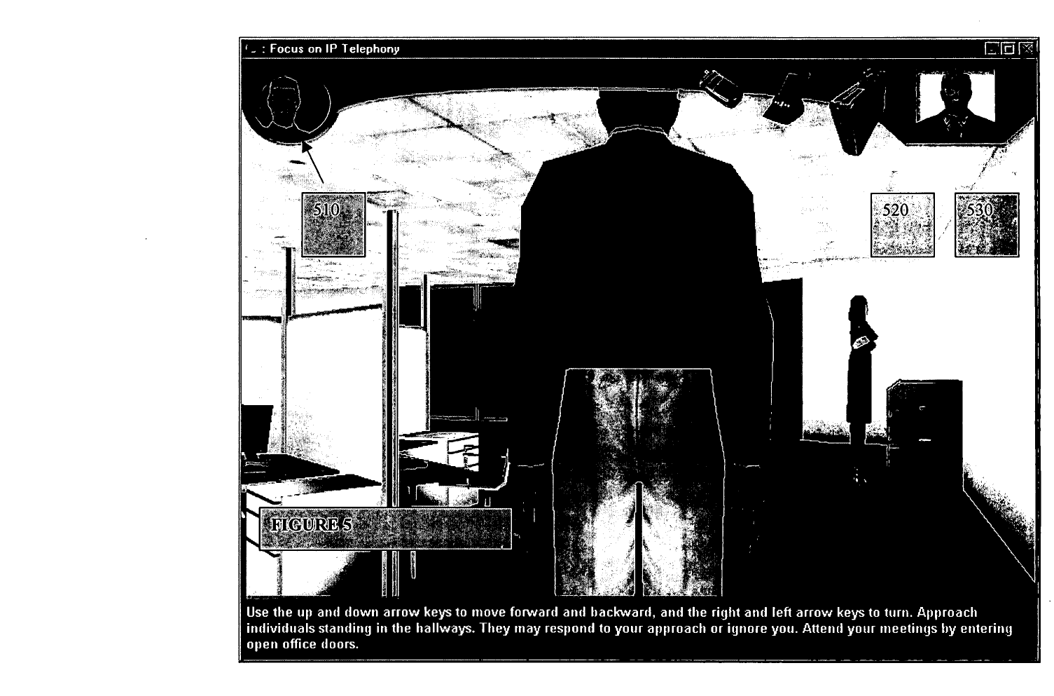

Referring to FIG. 5, the user character may be navigated through the client environment by depressing the “up” arrow key to move forward. The “down”, “left” and “right” keys move the user's character back, left or right, respectively. Navigation text tips may appear on the bottom of the screen. Additional features on the screen may include a frontal view of the user's character (510) as well as a frontal view of other characters (520) within the simulation. Backgrounds (530) may be provided in for the frontal view of the character to indicate their state (i.e., red—distressed; yellow—neutral; green—satisfied).

The user may navigate the character through an open office door to begin a meeting. A character may begin the conversation. An audio file may be played again by clicking the curved arrow in the bottom right of the screen. When a selection(s) is clicked the blue arrow may change to a right-pointing arrow. The arrow may be clicked to continue. Once this arrow is clicked, the user may be locked into that interaction and may need to backtrack (including resetting said user's score to that earlier point) to an earlier point in the simulation to replay that portion of the simulation.

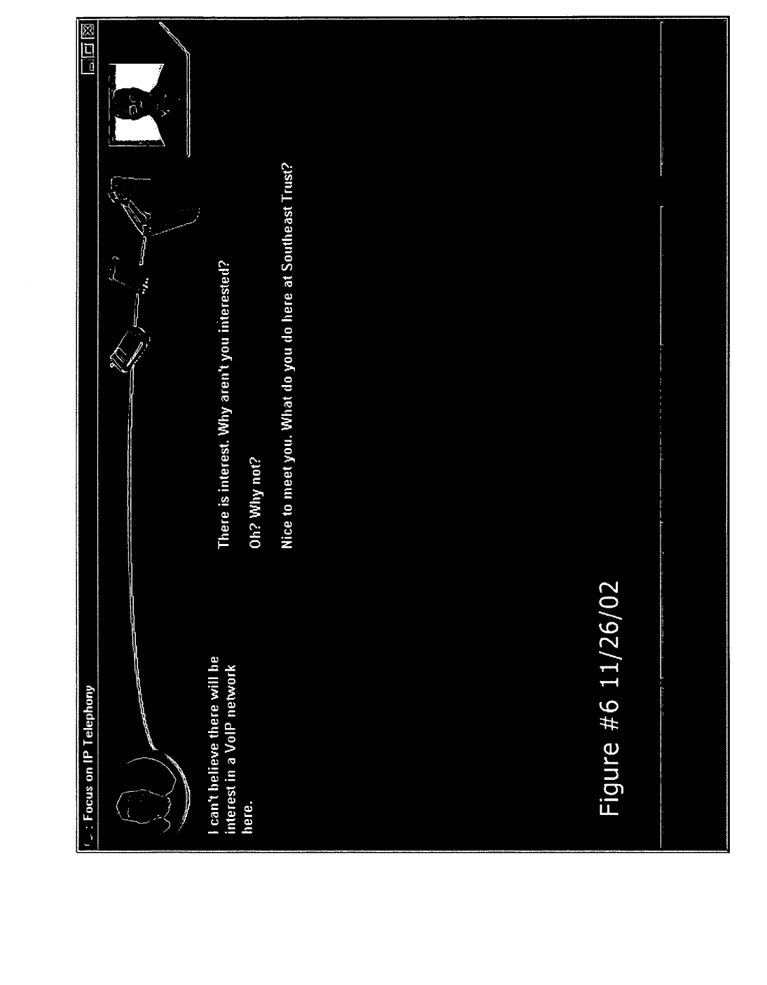

Referring to FIG. 6, custom, real-life-based information may be available in simulation dialog—provided user chooses correct selections and takes advantage of opportunities to speak with client characters (when available).

Within the simulation, the user may be the student taking the simulation. A character may be any of the simulated people the user interacts with during the simulation. An attribute may be a personal or professional interest for each character (i.e., a certain level of technical knowledge; a preference for baseball over football; or a severe dislike of cellular phones ringing during a meeting). Attributes may be scaled on a percentage formula (i.e., 0-100%) or via any other predetermined formula. The user may participate in interactions, which shall include meetings comprising a series of questions and answers. Referring again to FIG. 6, the user may choose from one or more selections during an “interaction” to answer a question, make a statement, or ask a question. A selection shall be a response that the user somehow “chooses” to proceed through the simulation. The “choice” may be completely structured, (i.e., a multiple-choice paradigm); semi-structured (i.e., fill-in-the-blank paradigm); or completely unstructured (simulation responds to typed or voiced commands that may be provided at user's discretion). Voice recognition technology may be integrated in said simulation to further enhance the reality of a given scenario. Artificial intelligence may be further utilized to analyze said user's response and determine the probity of said response. A default response may include a character responding, “I do not understand,” when said user input is not recognized by the system. The user will participate in several levels through the simulation. Levels may cover different topic areas that the user must progress through to complete the simulation.

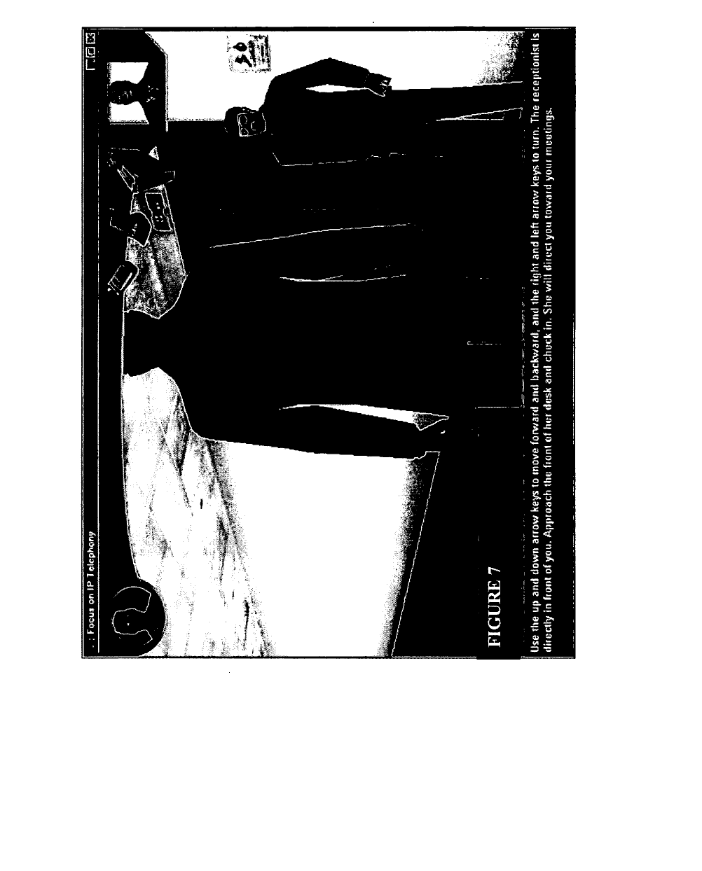

Within a simulation, the user may interact with different threads/rules depending on the responses they choose. Threads may be pathways through the simulation that may be logically connected. Rules may be pathways through the simulation that may be independent of a particular thread. A rule may even supersede a thread and place the simulation into a new thread. Finally, referring to FIG. 7, users may encounter unplanned events where characters that may or may not be involved in the meetings will be in the hallways or other areas of the client building environment. Scoring as well as future threads/rules may be based on where the user chooses to navigate within the simulation, specific responses or actions within the environment and even the time it takes the user to complete an interaction, thread/rule or the entire simulation.

Referring again to FIG. 7, when a user approaches one of these characters, an unplanned event may be possible. Navigating a certain distance from the character will cause the character to interact with the user. This may be a potential opportunity to find “key” information. Through research and positive results from unplanned events, especially important “key” information becomes available to the user. This information allows the user to distinguish between higher and lower quality selections during interactions. When “keys” are used during an interaction, the user increases the quality of options available during the design proposal creation. The higher quality options may allow for a larger sale value.

Feedback relating to the user's navigation of the simulation may be provided based on specific clicks made by the user. This information may be compared with back-end databases to provide critiques, projections, etc.

Development of the Storyline

The storyline to be simulated may be developed from a variety of sources including real-life scenarios and the imagination. It may be preferred to construct the scenario from real-life situation as much as possible so that the simulation will seem as realistic as possible. For instance in constructing a simulation surrounding an IP Telephony sale, many sources may be utilized to create the simulated scenario. First, the draw from the successful sale of an EP Telephony solution to an entity with many branch locations. Second, the simulation may include elements from a sale where the effort required by the salesperson was significant to overcome objections to IP Telephony from major users in this account. Finally, data drawn from interviews with users detailing various experiences when selling IP Telephony and other solutions.

A simulation engine may comprise a script, which further comprises a multi-path/multi-rule storyline that may be effected through the use of Parallel Streaming and Conditional Branching with Optional Scenes structures.

Parallel Streaming allows for several storyline paths to exist simultaneously at the various levels within the simulation. This structure allows a case study storyline to be modified into a multi-path, interactive simulation. The user, based upon decisions made, can alternate between these paths of the story, increasing or decreasing his or her standing with the client group.

The Conditional Branching with Option Scenes structure allows users to deviate from, then return to, the main storyline. The user may navigate through one or more interactions before returning to the main storyline, possibly discovering information that is useful later in the simulation.

Specific user selections can alter the storyline path taken during the simulation. Overall score also can alter the storyline path the user experiences during the simulation. The path may depend upon clicks and score combination.

Unplanned events may be loaded or not loaded for each level on a random basis. Which unplanned events are active is decided at random when the level loads. For instance, if there are two unplanned events per level, both characters will appear, but only one may be active. The next time the simulation starts the second unplanned event may be active instead of the first. The path the simulation follows may be different based on user clicks, availability and use of unplanned events. Essential topics, however, may be covered regardless of score and clicks (these may be common to all users that go through the simulation).

Character Development

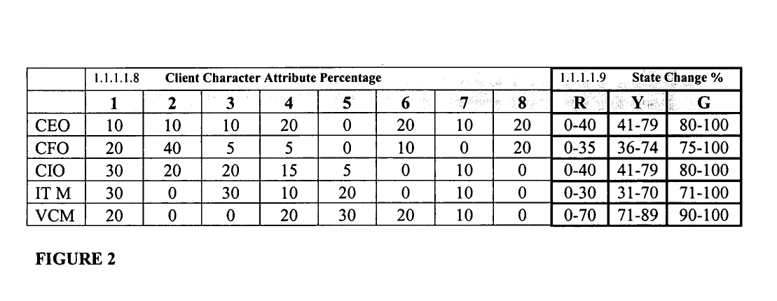

Referring to FIG. 2, the user may encounter a variety of characters in the simulations. These characters may be developed in advance to facilitate the particular simulation that is being run. Personalities of these characters will be based on the setting of particular attributes (i.e., character intelligence) and different characters may have different attribute settings.

A variety of characters can be interacted with in the simulation (i.e., a chief information office (CIO), chief financial officer (CFO), chief executive officer (CEO), internet telephony manager (ITM), and voice communications officer (VCM)). Characters may be found in the environment and within meetings. It should be appreciated that any number of characters may be provided in a simulation.

Interactions with characters may contain sound files as well as scrolling text on the bottom of the screen.

The icon above the client character monitors the client character's reaction to the user's selections. It may change between green, yellow, and red based on the client's reaction to the presentation. Green indicates the client is happy. Yellow suggests neutral or unconvinced. Red indicates unhappy. If one character met with during a meeting is red, at the end of the level, the simulation may end prematurely. Additional emotional states may be further defined in other embodiments, however, only three are presented herein for the sake of simplicity.

The matrix defining the number of characters that have attributes and can be scored in the simulation may comprise any number of characters and combination of attributes. An administrator responsible for setting up the simulation may define these attributes. An administrator may design a simulation very quickly. In an alternative embodiment, a user interface may be provided to facilitate an administrator in setting up the desired simulation according to their desired parameters this would allow intra-company customization of the simulation to easily customize the simulation to suit particular training needs or nuances existing within that company. The more characters, the more complex the simulation will be; therefore, it is recommended to start with a manageable number of characters and attending characteristics, i.e., eight characters with each character comprising eight characteristics.

Characters have personalities that may be defined by their attributes. Each attribute may identify a personal or professional interest for each character. Referring again to FIG. 2, attributes may be scaled on a 0-100% range indicating the interest level for an attribute for each client character. Other scales may also be used to define the characters.

Characters may also be defined via their predisposition to various aspects of the simulation. Although it should be appreciated that practically any area of subject matter could be integrated into the simulation, the following will illustrate the current principal by providing a matrix indicating a set of character's predisposition toward elements in a telecommunications sales call. Character attributes may be set by the administrator. It should also be appreciated that any other attributes that may be conceived for a simulation may be facilitated by the described method.

For the example scenario of an IP Telephony Sale, the following attributes may be set: Implementation, Cost, Security, Quality, Competition, Features, Scalability/Upgrades, and Revenue.

a. Implementation may cover a character's predisposition toward such factors as installation cost and time (workload, staff reduction), network complexity (wiring, WAN, number of disparate systems, and number of vendors at branch sites).

b. Cost may represent a given character's predisposition toward costs generated annually, monthly, for changes and upgrades, and for maintenance.

c. Security may represents the character's concerns regarding the integrity of the system that is being sold, i.e., whether the platform is Windows 2000 or if it is being deployed over a general network.

d. Quality may represent the characters concerns over the quality of communications once the system is deployed. Competition may represent a character's particular preference for a brand (i.e., Cisco) or other competitor system. Alternatively, it could represent a character's bias against a particular type of technology, i.e., IP Telephony.

e. Features may represent the character's desire for extras or for particular functionality in the system, i.e., PBX-type, XML applications and uses (current/future).

f. Scalability/Upgrades may represent the character's concern regarding having the most up-to-date system or there desire that vendor have a centralized place where they can add new features without disrupting their day-to-day business operations.

g. Another attribute, Revenue, may represent the character's concern over the expenditure or return on investment for purchasing the system being proffered. This attribute may also represent the characters desire to vertically develop the technology including the development of, for instance, online banking, ATM apps, and XML ads.

Referring to FIG. 2, depending on user responses to the simulation, the various attributes may be scored and a cumulative value may be assigned to the character, which may be represented by an icon to provide feedback to the user of their progress within the simulation.

Thread/Rule Design

For simplicity, the threads/rules within the simulation are presented at three levels of criticality (green, yellow, and red). It should be understood, however, that more complex levels/sub-levels may be generated and implemented and that such complexity may lead to a richer, more realistic simulation overall. Threads/rules may comprise green, yellow and red versions that cover a key topic. Green threads/rules may have client statements/questions that may be in a positive tone of voice and may contain one or more bits of information useful in responding to the client statement/question in this or other threads/rules. Yellow versions may contain the same selections, but the tone may be neutral and little or no extra information is included in the client statement/question. Red threads/rules may contain terse tones and provide no extra information.)

A user enters a thread/rule that may contain green, yellow and red components based on score (within the upper, middle or low “x of y score” thresholds).

Script Development—Thread/Rule Design

To develop a set of threads/rules, the administrator may first identify one or more key topics that are to be tested via the simulation. Next an interaction structure may be developed (meetings, levels, content within both, and pathing). Attributes may be defined to enhance the interaction structure. These may be based on key topics from case studies and/or interviews. Finally, a preliminary scoring methodology (constant, average scale) may be developed as well as key information to contain debriefing material.

A thread/rule may include several components including an identification moniker. The moniker may identify the level, meeting and thread/rule numbers (L10_M10_T10_R10) where L, M, T, and R indicates the Level, Meeting, Thread, and Rule numbers. Sections may be labeled using multiples of 10 for flexibility or via any desired protocol. As additional levels/meetings/threads/rules are filled into the script, they may be named from 0-9, 11-19, etc.

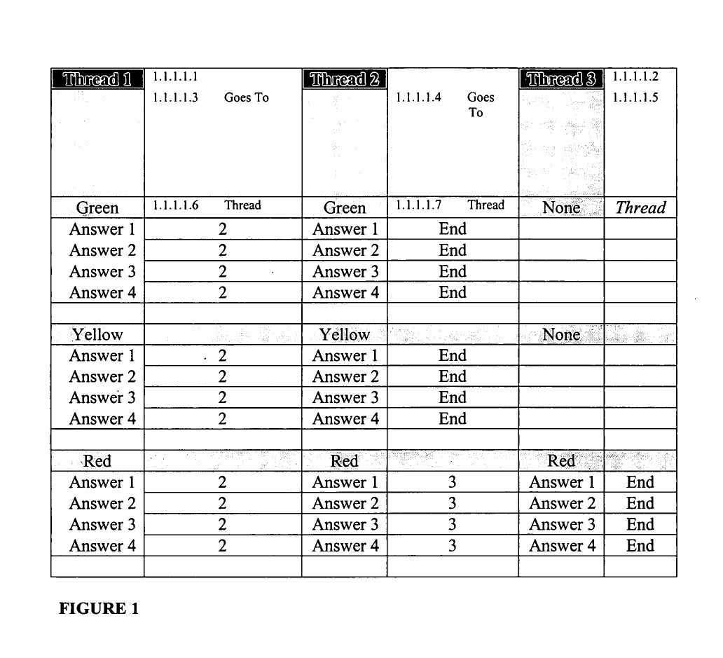

Referring to FIG. 1, thread/rule design may include a green, yellow and red section (for key information or areas in the sales process) so that the user may gauge his performance during the simulation. The administrator may define the characters to be involved in the thread/rule as well as statements/questions that may be posed by those characters. The system may utilize a mark up language (commercial or internally developed) so that the author/administrator of the simulation script can easily create a script and the conditions that script elements will have on the favorability of the person speaking that script (green, yellow, red). In one embodiment, questions may be asked of the user through a speaker, however, the administrator may also define an abbreviated version of the character statements/questions for display on the screen. It would also be possible to include full statements/questions; however, this may produce more clutter on the screen than desired.

The administrator may also define a set of response selections that the user may choose from to respond to the character statements/questions. In one embodiment response may be selected from a list. In another embodiment, the user may build the response through the selection of stem sentences in conjunction with a list of additional predicates.

Each response may be assigned at least one attribute weight using a predefined scale (for instance, weight each selection on a scale of 0-5 scale). The scores may be designed to indicate how completely the chosen response matches the character's business need or personal preference. Specific attributes may not be pertinent to a given selection and may be assigned a null or otherwise filterable value. These weights may be further scaled according to a predetermined formula. Responses may also have a specific thread/rule allocated to them so that the next thread/rule may be loaded upon selection of a given response.

The administrator may also design the debriefing session for predetermined intervals in the simulation. Debriefing text—threads/rules comprising important topics may include debriefing text that may be built dynamically based on user selections. The debriefing feedback may be displayed as an email message when the user is in this office. This text should mention the client character, details of the statement/question, details of the selection and specific feedback, which may contain why the selection was a correct or incorrect response. This text may preferably stand by itself, without the need for the user to remember the conversation in which this selection was included.

Referring again to FIG. 1, the administrator may also incorporate pathing into the threads/rules so that each user response identifies the next thread/rule to be played within the program. Each selection can have the same thread/rule identified or can branch to another thread/rule in the storyline flow.

### EMBODIMENTS

In one embodiment, a simulation may begin by providing an introduction to the simulation and the objectives thereof. This may include a short explanation as to the difficulty level of the particular simulation. This introduction may comprise a video, which outlines this material and acquaints the user with the tools he may use to interact with the simulation (i.e., commercials, flowcharts, literature, benchmarks, comparison studies, graphics, websites, etc.).

In another embodiment the user may traverse the simulation as follows: the user first enters the user office (pre-level one meetings). A simulated desk phone rings, and a light flashes until the user clicks the phone. An audio file may play while text simultaneously scrolls in text window. The phone call may end with “telephone hang up” audio clip. The user may then click on the “check messages” icon. A first message may comprise level one feedback. A second message may be from a client character. In one embodiment, the check messages option may not be available until the user has been introduced to the simulation via the phone. After conducting certain meetings, the user may return to their user office (pre-level two meetings). Once the level two meetings are concluded, the user may return to their office (pre level three meetings). This may continue for as many levels as desired by the designer of the simulation.

Additional phone calls, e-mails, messages may occur in each of the visits to the user office. It may also be possible to integrate cell phone calls or Blackberry messages in the course of a meeting to test the user's spontaneous responses. Messages may include debriefings or feedback regarding performance in the previous level. Once all of the planned simulation meetings have occurred, the user may return to the user office. A thread/rule may play (green, yellow, or red) which may be based on the final simulation score. The user may also receive feedback for their overall simulation performance based on selections from the final level. The header for this message may tell the User to read the feedback and note that the simulation is over. The simulation may end with fade out to the simulation credits.

In another embodiment, the focus of the simulation may be to provide users the opportunity to practice decision-making skills and to match IP Telephony features, benefits and value to a customer's current and future needs. Again, it should be appreciated that practically any situation might be simulated and that this invention should not be limited to EP Telephony sales or even sales generally. Practically any training situation may be developed through the simulator. For instance, the software may be used to simulate a trial situation to train new attorneys on the dynamics of interacting with a judge, jury, the client and opposing counsel. In another embodiment, the simulation software may be programmed to mimic a job interview or series of interviews to a desired discipline.

For instance, an embodiment that deals with an IP telephony sale may comprise four levels including Overview/Discovery, Technical/Design, Financial Justification, and Close. It will be appreciated that many more or different levels may be constructed to develop the best possible simulation.

In the current embodiment of an IP (Internet Protocol) Telephony sale, the simulation may utilize actual examples of interactions users have experienced during IP Telephony sales to make the interactions seem more realistic. The simulation may address such elements as presenting the value of IP Telephony to the client team in language each person can relate to. (Example: relating IP Telephony functions to those of a traditional telephone system to a Voice Communications Manager, rather than speaking in IP terms). The user may also have to explain Return on Investment in terms relative to the needs and current expenses of the business. (Example: showing potential hard and soft cost savings and revenue increases). The user may also be required to reach non-traditional members of the client organization with the benefits of IP Telephony. (Example: identifying XML application benefits to a VP of HR). The simulation may further allow the user to identify and address issues planted by competitors. (Example: a PBX provider tells the Voice Comm Manager that your company will have to completely replace all current equipment to successfully deploy IP Telephony).

In another embodiment, a two-minute video introduction may be presented to the actual account team for the case study/simulation. This may provide brief introductions to the key characters, issues, basic information about the sale, and the company that the user will be faced with in the case study.

In one embodiment, once the user has completed the introductory material, the simulation may place the user in his office. The user has the option of researching materials internal to the simulation (Briefcase) or through external links to other sources (PDA). Opening the briefcase shows a page with a list of links to various research materials. If the research material for a link is more than one page long, there may be a “More” button at the bottom of the page that takes the Player to the next page. The user has the option of researching materials through external links to other sources (PDA). Opening the PDA shows a page with a list of links to various external Internet sites.

The user may check his messages by clicking on a message area that may include instructions that the user is to follow (i.e., the first of two scheduled meetings during this level (“round of meetings”). Clicking this option may also allow a user to request a meeting with any client character. The request may or may not be granted.

In the example script, the user may be taken to the client building and given directions to the appropriate office for the meeting. The user may be free to navigate in the environment and locate the meeting room. The simulation may be programmed so that if the user breaks the plane of the office door, a movie begins showing the client characters and user greeting each other. Pertinent introductory information may be spoken (via audio and/or sub-title type text in a box at the bottom-center of the screen). The movie may end with a character asking the user to make a statement or answer a question. Presenting movie clips featuring human beings as the actors may provide a more realistic interface, where possible, than an application, which utilizes pure computer animation although any combination of the two technologies is possible.

In one scenario, neither of the attendees at the meeting (for example, a voice communication manager—VCM and an IT Manager) may have any interest in IP Telephony. The VCM may be fearful of losing the value-add of his services to another provider. IP Telephony is new, unfamiliar technology. Poor quality of voice over IP may be another concern. Additionally, the IT Manager may be unfamiliar with IP Telephony and may be concerned about reliability and the already high workload of the IT unit.

To achieve a positive score, the user must relate to the VCM in terms a voice specialist can understand, and relate IP Telephony terms to the voice terms the VCM knows. The user must also relate IT Manager in a way that shows the network will be able to support IP Telephony and the change to a converged network will be reliable and not increase the IT workload.

The user may answer the question, make a statement, or ask a follow-up question. Additional movie clips may be interspersed to “act out” the user's selections.

When one meeting ends, a character may instruct the user with directions to his next meeting or, if no meeting is currently scheduled, the user may return to his simulated office.

In the example scenario, a second meeting may be scheduled with the Chief Financial Office (CFO) and the Chief Information Office (CIO) of the company. The CFO and CIO may be programmed to be willing to listen to the user, but have little or no interest in IP Telephony. The PBX provider has told the CIO that client candidate will remove their current network entirely and replace it with an expensive, unreliable network that has poor voice over IP quality. Further sophistication may be programmed into the simulation by providing that any willingness to listen may be based upon a plan to perform maintenance and upgrades over the next 2 years on disparate key systems among many of the 750 branches. Bonus point may be rewarded for an offer to upgrade the entire data network. Having many dozens of various systems in the branches, as well as voice-only point to point circuits adds to the interest of cost reduction, and multiple vendors servicing each branch.

In this scenario, the user must convince the characters of the viability of IP Telephony in this high-level meeting. The CFO must be shown a high-level ROI calculation (possibly using information provided in the customized research materials in the user's briefcase) that makes IP Telephony worth investigating. The CIO must be shown that the network can support IP Telephony and that the quality of voice service will be high. Also, since the company is considering upgrading their data network, IP Telephony is not an expensive addition to the system.

Once again, the simulation may be activated by the user answering a question or making a statement. This may, again, be “play-acted” via movie clips. If the user successfully completes this level, the CIO may agree to attend a demonstration of IP Telephony at the user's office.

In this embodiment, there may be one or more unplanned events possible. If the user navigates near an “active” character in the hallway and performs well during the ensuing interaction, important information can be gained. Once the simulation is complete, the user will be returned to his “office” for a debriefing session.

If all client characters involved in interactions in this round of meetings are in a “red” state, the simulation ends. If one or more of the client characters are not in a “red” state, the user will have the option to do more research or schedule more meetings.

In another embodiment, the simulation may advance the user to the next level (or the user may proactively choose to begin the simulation at a higher level)—in this scenario, this may be the Technical/Design Meeting Level. The user may be taken to the client building and given directions to the appropriate office for the meeting. The user may be free to navigate in the environment and locate the meeting room. In this scenario the CIO has been receiving reports from the VCM and IT Manager about the unreliability of IP Telephony. The user's role may be defined as the need to address the concerns of the CIO and to gain an executive sponsor for the push for IP Telephony. Once again, video/audio clips may be integrated into the simulation to increase its sense of reality. Multiple interactions may occur between the characters in this scene. In another meeting, the IT Manager may be skeptical. The issues raised include reliability, feature functionality, concerns that the network may be unable to handle the new technology, and that the IT department workload will dramatically increase as a result of IP Telephony. The IT Manager may still be unclear about how the technology works. The decision to pursue IP Telephony as a possibility has been made by an affiliate organization and the VCM may be apparently agreeable to investigating it more. The VCM has a close relationship with the PBX vendor. The vendor has been suggesting questions to ask the user that may prevent a sale.

The user must answer the questions in terms familiar to the VCM and provide solid reasons why the problems identified (apparently) by the PBX vendor are not a concern. The user must answer the questions in terms familiar to the VCM and provide solid reasons why the problems identified (apparently) by the PBX vendor are not a concern. Finally, the user may begin developing a design based on identified needs from the VCM and IT Manager. Again this meeting may comprise multiple interactions between the characters before it reaches a conclusion.

The purpose of these detailed scenarios is not to limit the depth or breadth of the simulation but, rather, to illustrate the rich functionality possible in such simulations. Practically any storyline may be broken down into interactions, choices, etc. so that it may be played out via the simulator.

Once a particular meeting or simulation has ended, if all client characters involved in interactions in this round of meetings are in a “red” state, the simulation ends. If one or more of the client characters are not in a “red” state, the user will have the option to do more research or schedule more meetings.

In another embodiment, the simulation may run a financial justification scenario. Here, the user may be taken to the client building and given directions to the appropriate office for the meeting. In general, the user may be free to navigate in the environment and locate the meeting room. Unplanned events may be integrated into the simulation should the user choose to explore his surroundings. This meeting may involve a CFO and CIO who may still be concerned about ROI and other financial considerations of a converged network. They want answers to specific questions concerning the cost of implementation, installation, maintenance, and upgrades.

The user role in this scenario would be to demonstrate the feasibility of IP Telephony for the entity, answer questions using language appropriate for the client characters, use specific responses that address current business needs, create needs by identifying features and applications that increase revenue and reduce costs, create interest by identifying features and applications that increase client character convenience and productivity. The user may earn additional points by identifying relevant ROI areas that demonstrate cost savings and revenue generation. These objectives may take be played out over one or more interactions with the current characters that may be facilitated through statements, questions, and answers as well as playacted through video clips. After this scenario is completed, if one or more of the client characters are not in a “red” state, the user will have the option to do more research, or create the proposal for the design and schedule the final meeting. The user will be given the available options to create a design proposal.

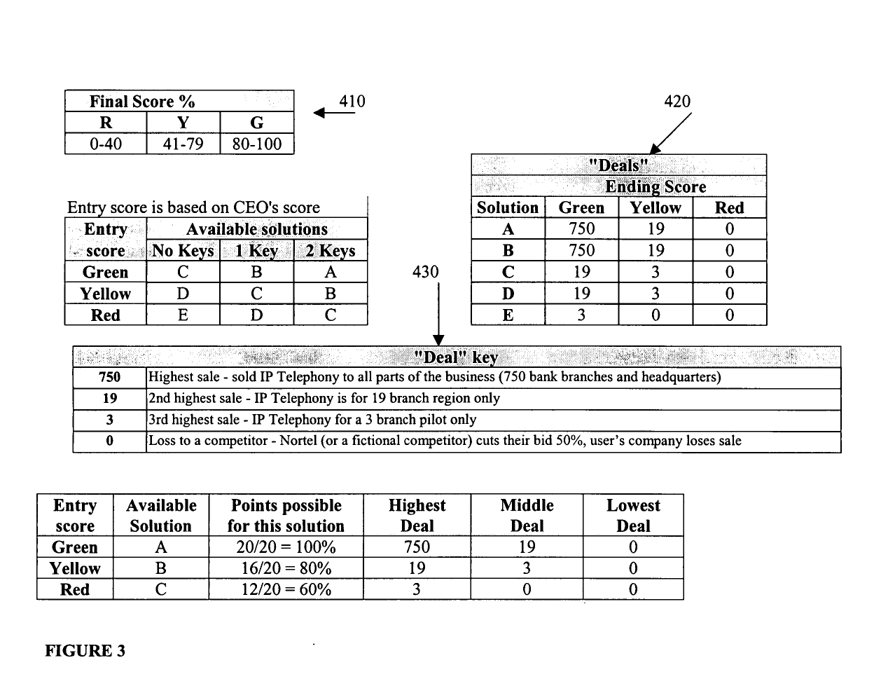

Referring to FIG. 3, user may select a design option and bridging statement for each network design category. Each solution may have a maximum value associated with it (i.e., Solution A has the highest quality rating). After making all selections and clicking the “Next” button on the Category 4 bridging statement, Player goes back to the User office. Player may have the option of restarting the design proposal creation or clicking the car keys to go to the close meeting. The simulation may restart with the assumption that the design has just been presented to the other characters. The movie illustrating this sequence may end with a client character asking the user a question about the design proposal. The entry point to this meeting may be based upon the score of the technical options and bridging statements. Client issues for this part of the simulation may be final concerns with the design and ROI. The user's role may be to address these concerns and close the sale. Characters may propose changes to the design in the course of this phase of the simulation. User responses to these requests will be factored in to determine the final value of the available sale (available sale value may be based upon performance in Levels 1, 2, and 3). Lower scores and a lack of “key” answers given in previous levels result in less attractive options for design creation. For instance, the sale outcomes for this story line may include a 3-branch pilot, a 19-branch pilot, a full sale to all 750 branches, no sale, or some combination of these options. It should be appreciated that many more outcomes may be coded; however a limited number is presented here for the sake of simplicity.

Scoring

Scoring for a particular interaction may be dependent on how the attributes for various characters are set of that scenario.

For each interaction/thread/rule, each user may be scored based on their responses and the attributes assigned to the characters that they interact with in the scenario. In one embodiment, calculations may be based on an “x/y” score (x points earned out of y possible).

It should be recognized that the scoring mechanism as well as the individual values/scales assigned within the example scoring mechanism are purely for example only and that the simulation may facilitate virtually any conceivable scoring mechanism designed. As an example embodiment of one possible scoring mechanism, each selection that a user may choose may be set to a value of 5 (this may be called the “constant” value). Each time a selection is made, all characters in the simulation may be scored based on the character attributes that they are assigned. This emulates internal communication among the client characters (although the “internal communication” happens instantly after making a selection).

Attributes for client characters may be based on 0-100% interest for each attribute. Every attribute covered in each selection may be identified and assigned a numeric quality rating. This rating may be on a scale from 0-5, with 5 being the highest score. An attribute can have a “null” value if it is not covered in the selection, and is consequently not scored.

Each selection also has a scale. The scale may be a multiplier for the selection that can be 0 (which causes the selection to have no impact on the user's overall score) to infinity. An “x” in the .XML attributes area denotes a null attribute. Both the points earned and points possible (constant) may be multiplied by each attribute identified in the selection. With a scale of 10, a selection has a value of 50 points. If the quality rating of each attribute covered in the selection is 5, the user will earn 50 points out of 50 points possible. With a quality rating of 2, the user will earn 20 points out of 50 possible.

Meetings with 2 or more users have their thresholds averaged to determine the overall meeting score (a “red” score for any user will result in the user not being able to advance to the next level). User threshold calculations may be based on an “x/y” (percentage) score (“x” points earned out of “y” points possible). The points the user can earn in a selection may be calculated by multiplying the quality value of the attributes represented in the selection and the attribute percentage for each client character.

For example, a selection covers only one attribute (cost). The user chooses the selection that has a cost attribute quality rating of 5. The scale for this selection is 1. The CEO has an 80% interest in cost. Therefore, the user will earn 4 points (5 points×80%). Consequently, the user earns a 100% score for choosing that selection. However, the value of the selection is reduced 20% due to the CEO only having an 80% interest in cost.

The total possible points for the selection may be calculated by multiplying the constant and the client attribute percentage. In the above example, the possible points for that selection is 4 (5×80%). When more than one attribute is represented in a selection, the “x” and “y” values for each represented attribute may be added together to create a total value for that selection.

To calculate user points earned: Client character attribute % * selection attribute weight x scale. To calculate total points possible: Client character attribute % * constant * scale. To calculate total value of a selection: Add user points earned divided by added total points possible.

For instance, scoring may be set up so that each thread/rule may have a scale (multiplier) depending on its criticality to the overall scenario. Attribute values in a thread/rule may be multiplied by the thread/rule scale and client character attribute % to determine total value of a selection in a thread/rule for each client character. The following formula may be utilized:

(attribute 1×client character attribute 1 percentage)+(attribute 2×client character attribute 2 percentage)+(attribute 3×client character attribute 3 percentage)+(attribute 4×client character attribute 4 percentage)+(attribute 5×client character attribute 5 percentage)+(attribute 6×client character attribute 6 percentage)+(attribute 7×client character attribute 7 percentage)+(attribute 8×client character attribute 8 percentage)×(scale)=Total score for that selection.

Scores developed during various meetings/interactions may determine whether a user is permitted to move onto a new meeting, a new level, or even complete the simulation

Referring to FIG. 3, once the user advances to the closing meeting (or whatever conclusion is deemed appropriate for the designed simulation), a final score (410) may be calculated to determine the user's level of success for the simulation as a whole. In the example embodiment presented through this application, an IP Telephony Sale, the deal value (420, 430) may be based upon the following rules. It will be appreciated, however, that alternate scoring systems may also be designed, implemented, and executed. Depending on the final score, any number of outcomes may be matched to the score to provide feedback to the user as to his or her success. An entry score of Close Meeting may be based on points scored during design (technical) option and bridging statement selections (design options and bridging statements may be scored the same as other threads/rules).

Referring to FIG. 4, in calculating the final score, the user may select a design option and bridging statement for each network design category to present at the closing meeting. Each solution may have a value associated with it. Practically any formula may be employed to construct a final score. In one embodiment, the final deal may be based on a score calculated from the CEO's reaction to the presentation. Attributes listed in the CEO attribute % table may be completed for the each selection. The best selections in a thread/rule will be tagged so that 100% of the CEO attributes may be tagged with either a 5 (for deal A), 4 (for deal B), or 3 (for deal C). Based on the total number of points accumulated a green, yellow, or red score may be issued for the simulation as a whole.

Referring again to FIG. 4, the user's final simulation score (410) (and the total sale the user “wins”) may be based on an average of all scores.

Debriefing

The user may receive further feedback regarding how the choices made during the simulation impacted the final outcome of the simulation. Each selection made by the user throughout the simulation may be tracked. Specific attributes for each selection may be revealed to the user. The value of each attribute in each selection may be identified and the user may be shown how the scores were calculated by matching the attributes of the characters with the attributes of the selected choice to derive a final score.

Engine Specifications

It is to be understood that the following technical specifications represent only one embodiment by which the disclosed invention may be embodied. One skilled in the art may easily devise any number of specific embodiments. The simulation may be run through the WildTangent plug-in in a web browser, preferably version 3.0 or later. The simulation may also be run through a Flash plug-in through a web browser such a Flash 5.0 or any equivalent or to be developed plug-ins.

Purely for explanatory purposes, the simulation may be delivered to the user's PC over a sustained Internet connection or through a download/install version available on a web site. The invention may perform well using Microsoft Internet Explorer version 5.0 or later; 3D accelerated video card with at least 8 MB of video memory (16 MB recommended); Microsoft Windows 98 or later; Microsoft Windows Media User version 7.1 or later; 64 MB of system RAM (128 MB recommended); and Microsoft DirectX version 7 or later version (version 8.1 recommended). Similar technologies may be utilized to effect this invention both current and to be developed.

The simulation may be associated with a dedicated web page that may contain links to a tutorial (that may be developed in Flash 5.0), associated videos, help pages, and a Frequently Asked Questions page. A start button may be located on the page to begin the simulation. A model may be chosen that will represent the user in the simulated environment.

The simulator engine may be varied to include multiple users to participate simultaneously regardless of geographic location. The simulator engine can incorporate video game devices such as controller pads and joysticks for functionality. The engine can utilize simultaneous communication of multiple players via the Internet. The simulator can incorporate the use of varying output devices such as personal display devices and video glasses. The simulator engine can be modified easily to any program language such as C++, Visual Basic, Lingo, and net. It will be appreciated that, using ordinary skill in the art, the simulator may be embodied in a variety of game hardware/software.

XML File—Description

The script and associated information may be placed into one or more XML files in order to be displayed on screen in the simulation. Associated information includes Attributes, Client characters, Client character attribute percentages, Client character green/yellow/red threshold percentages, User character models, Level file names, Research contents, Prompt text (appears on the bottom of the screen in the office and when not engaged in an interaction in the client environment). It should be understood that XML is merely the preferred method and that any method for storing scenarios, attributes, etc. may be utilized to implement the simulation engine.

The same or additional XML files may be directed to specific levels. These files may contain client representative email text (meeting time, location, attendees); Unplanned Event threads/rules; Client characters participating in the level; Meetings in the level; and Threads/Rules (with scoring information and where each selection takes the user in the storyline path). There may be additional XML files, which comprise e-mail debriefing text that may contain specific feedback for user selections chosen during the simulation. There may be additional XML files which may be directed to specific levels that comprise Telephone call feedback (green/yellow/red versions); Email message text; Header may contain text that appears before dynamically created feedback text; Footer may contain text that appears after dynamically created feedback text.

XML files may be used in the simulator by populating all information between tags, or within quotation marks. See the sample below:

```
<selection weight=“5,x,5,x,x,x,x,x” scale=“8”
        debrief=“L20_M10_T45_3”
        next=“L20_M10_T50”>Text is
        here.</selection>
```

In the sample above all information is within the selection tag. Within the selection tag may be the weight=, scale=, debrief=, and next=tags (see below for a description of these and all tags). The tag ends with the /selection tag. No information should be entered outside of these tags.

This section may contain descriptions of the “tags” used in the XML files and what information may populate these areas.

1) Level—Beginning

Sample XML code for defining a level is provided below.

<level id=“L20” ordered=“false”
debriefFilename=“L20_D.xml”>

This area identifies the names of the level and debrief filenames. The components may include:

a. level id—the name of the level indicated in the s3.xml doc

b. ordered—can be true or false (true means the level has meetings set in a specific order, false means that the user can attend the meetings on that level in any order)

c. debriefFilename—the name of the file containing the Regional Manager feedback (phone call and email text)

2. Messages

Sample XML code for defining messages is provided below.

<Messages>

This area may be for the email messages from the client company. One may be positive (meaning that the user can continue in the simulation—this message includes who will attend the next meetings). One may be negative (the client sends this message when one of the previous meetings ended in the “red”—this message states that no further meetings will be held. After this message appears, the simulation ends). The components may include:

a. positive—indicates that the message will include additional meetings

b. negative—indicates that the performance of the dictates that no further meetings will occur (simulation prematurely ends)

c. message—indicator that the next tags may be for an email message

d. from—the sender of the email message

e. to—the email message may be to the user

f. subject—subject of the email

g. text—body text of the email

3. Unplanned Events

Sample XML code for defining an unplanned event is provided below.

<unplannedEvent id=“L20_UE1”area=“elevator”><participants><participant id=“8”/></participants><thread id=“L20_M10_T45”><explanation>Feedback for this thread. </explanation><dialog participant=“3” audio=“L20_M10_T45.wwv”>Client character statement/question goes here.</dialog><slide>Text that appears on the screen next to the selections goes here. </slide><response type=“1”><selection weight=“5,x,5,x,x,x,x,x” scale=“8” debrief=“L20_M10_T45_{—}3” next=“L20_M10_T50”>Participant response text goes here.</selection></response></thread>

These tags may contain an unplanned event interaction. The limit to the number of unplanned events that can be used on a level may depend on the number of unplanned event areas defined in the client environment. The structure of this event may be otherwise the same as a meeting (see below). The components may include:

a. unplannedEvent

b. id—the unplanned event label

c. area—the area in the client environment that the character is located as defined in the client environment map

d. participants—indicator that the next tags identify what character may be in the unplanned event

e. participant id—numeric id for the unplanned event character

f. thread id—the thread label (in the level/meeting/thread/rule format)

g. explanation—this is currently not used, but was intended as feedback for this thread/rule (also called the “reveal” text)

h. dialog

i. participant—the client characters numeric identification

j. audio—the audio file associated with an interaction

k. slide—text that appears on the screen next to the selections

l. response type=

1—choose one selection from a list. Any number of selections can be placed here, the only limitation is how much information can fit on a screen

2—choose one selection from the top list and one from the bottom list. Each list has a stem sentence, allowing the participant to “build” an answer (see Meetings below for an example)

m. weight=quality rating for each identified attribute. Each attribute can have a number from 0-5, with 5 being the highest score, and zero being lowest. An “x” indicates that this attribute is not covered in the selection

n. scale=each attribute number may be multiplied by this scale. A higher number means that this selection may be worth more points (and can be used to emphasize important information the client has identified). A zero scale means that this selection is not scored

o. debrief=identifies the tag in the debrief.xml document associated with this selection. Debrief information is optional and may be primarily used for important topics

p. next=identifies which thread the participant moves to when choosing this selection

4. Meetings

Sample XML code for defining a meeting is provided below.

```
<meeting id=“L20_M20” area=“seMeetingRoom”> <participants>
    <participant id=“4”/> <participant id=“5”/> </participants>
    <thread id=“L20_M20_T10”> <explanation><p>Text is
    here.</p></explanation> <dialog participant=“4”
    audio=“L20_M20_T10.wwv”> <p>Text is here.</p></dialog>
    <slide> <p>Text is here</p></slide> <response type=“2”>
    <p>Stem text (1) is here </p> <list> <selection
    weight=“5,5,x,x,5,x,5,x” scale=“16”
    debrief=“L30_M10_T25_1” next=“L30_M10_T30”> Text is
    here.</selection> <selection weight=“x,x,x,x,x,x,x,x”
    scale=“16” debrief=“L30_M10_T25_2”
    next=“L30_M10_T30”> Text is here.</selection></list>
    <p>Stem text (2) is here,</p> <list> <selection
    weight=“x,x,x,x,x,x,x,x” debrief=“L30_M10_T25_3”
    scale=“16”>Text is here. </selection> <selection
    weight=“5,5,x,x,5,x,5,x” debrief=“L30_M10_T25_4”
    scale=“16”>Text is here.</selection> </list> </response>
```

The components may include:

a. meeting

b. id—the meeting label

c. area—the area in the client environment that the meeting is located as defined in the client environment map

d. participants—indicator that the next tags identify what character may be in the unplanned event

e. participant id—numeric id for the client characters attending this meeting

f. thread id—the thread label (in the level/meeting/thread/rule format)

g. explanation—this is currently not used, but was intended as feedback for this thread (also called the “reveal” text)

h. dialog

i. participant—the client characters numeric identification

j. audio—the audio file associated with an interaction

k. slide—text that appears on the screen next to the selections

l. response type=

1—choose one selection from a list. Any number of selections can be placed here, the only limitation is how much information can fit on a screen

2—choose one selection from the top list and one from the bottom list. Each list has a stem sentence, allowing the participant to “build” an answer

m. list—used with response type 2 to indicate more than one selection set is being used

n. selection

o. weight=quality rating for each identified attribute. Each attribute can have a number from 0-5, with 5 being the highest score, and zero being lowest. An “x” indicates that this attribute is not covered in the selection

p. scale=each attribute number may be multiplied by this scale. A higher number means that this selection may be worth more points (and can be used to emphasize important information the client has identified). A zero scale means that this selection is not scored

q. debrief=identifies the tag in the debrief.xml document associated with this selection. Debrief information is optional and may be primarily used for important topics

r. next=identifies which thread the participant moves to when choosing this selection

5. Meeting—Ending

Sample XML code for defining a ending meeting is provided below.

```
<thread id=“L30_M10_E”> <dialog participant=“2”
    audio=“L30_M10_E.wwv”><p>Text is here.</p>
    </dialog> </thread> </meeting> </level>
```

These tags may contain the last thread/rule in a meeting interaction. There is no limit to the number of meetings that can be used on a level. Components may include:

a. thread id—the thread label (in the level/meeting/thread/rule format)

b. dialog

c. participant—the client characters numeric identification

d. audio—the audio file associated with an interaction

6. Level—Ending

Sample XML code for defining the ending of a level is provided below.

</level>

A level ends with this tag (all tags end with the “/” prefix)

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method for computerized training comprising:
(a) designing a three-dimensional computerized simulation deployed over a two-dimensional media, wherein said simulation reproduces a training environment;
(b) programming at least one scenario comprising a projected sequence of events in said training environment, wherein said scenario further comprises at least one element from the following set of elements: meetings, phone calls, pages, e-mails, conversations, key information disclosures, and debriefings;
(c) programming at least one character in said training environment to interact with a user, wherein said at least one character provides feedback to said user by taking on at least one emotional state in reaction to a user's input; and
(d) programming said training environment to calculate a score for said at least one user input and, based on said score, provide a set of feedback to said user relating to said user's success with said element.

2. A method, as claimed in claim 1, wherein said emotional state is selected from the group consisting of happy, satisfied, neutral, unconvinced, confused, bored, sad, frustrated, and angry.

3. A method, as claimed in claim 1, wherein said at least one character's emotional state is reflected in at least one simulated reaction to said user, wherein said reaction comprises a set of positive statements and questions from said character when said emotional state is also positive.

4. A method, as claimed in claim 1, wherein said at least one character's emotional state is reflected in at least one simulated reaction to said user, wherein said reaction comprises a set of neutral statements and questions from said character when said emotional state is also neutral.

5. A method, as claimed in claim 1, wherein said at least one character's emotional state is reflected in at least one simulated reaction to said user, wherein said reaction comprises a set of negative statements and questions from said character when said emotional state is also negative.

6. A method, as claimed in claim 1, wherein said at least one character comprises attributes defining interests or characteristics of said character, wherein said attributes may be scaled by a predetermined formula to indicate an interest level for said character attribute.

7. A method, as claimed in claim 6, wherein said attributes indicate said character's interest level in implementation, cost, security, quality, competition, features, scalability/upgrades, and revenue.

8. A method, as claimed in claim 6, wherein said user input may cause characters to each develop an emotional state based upon each of said character's attributes and said scaling associated with said character's attributes.

9. A method, as claimed in claim 1, wherein said training environment is programmed to calculate a final score from said user's input and, based on said final score, provide a set of feedback to said user relating to said user's success with the simulation as a whole, wherein said feedback includes a projected of the outcome of said simulation.

10. A method, as claimed in claim 1, wherein said simulation is programmed to replicate litigation.

11. A method, as claimed in claim 1, wherein said simulation is programmed to replicate a job interview or a series of job interviews.

12. A method for computerized training comprising:
(a) designing a three-dimensional computerized simulation deployed over a two-dimensional media, wherein said simulation reproduces a training environment for telephony sales;
(b) programming at least one scenario comprising at least one element from the following set of elements: meetings, phone calls, pages, e-mails, conversations, key information disclosures, and debriefings; and
(c) programming a multitude of characters in said training environment to interact with a user, wherein said characters provide feedback to said user by taking on at least one emotional state in reaction to a user's input.

13. A method, as claimed in claim 12, wherein said simulation comprises at least four scenes including overview/discovery, technical/design, financial justification, and close.

14. A method, as claimed in claim 12, wherein said scenario comprises a user presentation of a telephony system to a group of characters wherein said group of characters may comprise a set of differing character attributes, and a score associated with said scenario is based on a formula which weights each of a set of reactions of said characters to said user presentation.

15. A method, as claimed in claim 12, wherein said scenario comprises a user providing input relating to a return on investment, and wherein a score associated with said scenario is based on said user providing a set of information relevant to a set of needs and current expenses of a business.

16. A method, as claimed in claim 12, wherein said scenario comprises providing an opportunity for said user to provide information relating to at least one competitive system.

17. A method, as claimed in claim 12, wherein said characters may include one or more of a chief information officer, a chief financial officer, a chief executive officer, an internet telephony manager, and a voice communications officer.

18. A method for computerized training comprising:
(a) designing a three-dimensional computerized simulation deployed over a two-dimensional media, wherein said simulation reproduces a training environment;
(b) programming at least one scenario comprising at least one element from the following set of elements: meetings, phone calls, pages, e-mails, conversations, key information disclosures, and debriefings;
(c) programming a multitude of storyline paths comprising one or more scenarios linked together by subject matter; and
(d) programming at least one character in said storyline paths to interact with a user, wherein said at least one character provides a set of feedback to said user by taking on at least one emotional state in reaction to a user's input.

19. A method, as claimed in claim 18, wherein said computerized simulation alternates between said storyline paths based on said user's input.

20. A method, as claimed in claim 18, further comprising the step of allowing said user to deviate from and return to a main storyline within said multitude of storyline paths.

21. A computer readable medium having computer executable instructions for performing a method comprising:
a. designing a three-dimensional computerized simulation deployed over a two-dimensional media, wherein said simulation reproduces a training environment;
b. programming at least one scenario comprising a projected sequence of events in said training environment, wherein said scenario further comprises at least one element from the following set of elements:
meetings, phone calls, pages, e-mails, conversations, key information disclosures, and debriefings;
c. programming at least one character in said training environment to interact with a user, wherein said at least one character provides feedback to said user by taking on at least one emotional state selected from the group consisting of happy, satisfied, neutral, unconvinced, confused, bored, sad, frustrated, and angry in reaction to a user's input; and wherein said at least one character's emotional state is reflected in at least one simulated reaction to said user, wherein said reaction comprises a set of positive statements and questions from said character when said emotional state is also positive and a set of negative statements and questions form said character when said emotional state is negative.
d. programming said training environment to calculate a score for said at least one user input and, based on said score, provide a set of feedback to said user relating to said user's success with said element.
